(19) United States
(12) Patent Application Publication
(10) Pub. No.: US 2013/0273847 A1
(43) Pub. Date: Oct. 17, 2013

(54) Method and Apparatus for a Mobile Safety Platform with Multiple Communication Interfaces

(71) Applicants: Jialiang Le, Canton, MI (US); Kwaku O. Prakah-Asante, Commerce Township, MI (US); Manoharprasad K. Rao, Novi, MI (US)

(72) Inventors: Jialiang Le, Canton, MI (US); Kwaku O. Prakah-Asante, Commerce Township, MI (US); Manoharprasad K. Rao, Novi, MI (US)

(73) Assignee: FORD GLOBAL TECHNOLOGIES, LLC, Dearborn, MI (US)

(21) Appl. No.: 13/444,207

(22) Filed: Apr. 11, 2012

(51) Int. Cl. H04B 7/00

(52) U.S. Cl. 455/41.2; 455/66.1

(57) ABSTRACT

A system includes one or more sensors, one or more output devices, a vehicle computing system (VCS) configured to receive information from the one or more sensors and to output information to the one or more output devices, a wireless receiver in communication with the VCS, and a wireless transmitter in communication with the VCS. The VCS is further configured to filter information received from the one or more sensors and broadcast the information through the wireless transmitter to a first device, while simultaneously communicating with the first device over the wireless receiver to receive a request relating to use of a vehicle output device, to verify the permissibility of the request and to provide output in accordance with a verified request over the vehicle output device.

### TECHNICAL FIELD

The illustrative embodiments generally relate to a method and apparatus for a mobile safety platform with multiple communication interfaces.

### BACKGROUND

BLUETOOTH devices with multi-point communication have recently been developed that allow a single device to communicate with more than one transmission/reception point simultaneously using a BLUETOOTH connection. Similarly, the capabilities exist for a single transmission point to communicate with a multitude of devices over BLUETOOTH. While these technologies are generally known, their existence paves the way for a variety of novel applications and implementations of systems not previously utilized.

U.S. Patent Application 2006/0240817 discusses a multi-wireless connection device that point-to-multipoint connects a communication link between a plurality of cellular phones to be connected to a cellular network, and a cordless phone that remote controls an outgoing call from the plurality of cellular phones to the cellular network or an incoming call from the cellular network to the plurality of cellular phones. The multi-wireless connection device maintains the synchronization within the Bluetooth network and performs point-to-multipoint connection by transmitting and receiving control data between the plurality of cellular phones via an asynchronous connection-less link. This is one example of an existing single transmission point to multiple receiving point device.

U.S. Patent Application 2008/0280655 discusses an in-vehicle navigation apparatus that performs the following: according to an initial operation of a user to register a handsfree function, connecting a handsfree profile with a cellular phone and registering a handsfree function to be associated with the cellular phone; if the cellular phone has an audio visual function, displaying an audio visual function registration window for querying a user whether to register the audio visual function; and according to an operation of the user to register the audio visual function, connecting an audio visual profile with the cellular phone and registering the audio visual function to be associated with the cellular phone that was registered as being associated with the handsfree function. This is an example of registering device profiles with a computing system related to a vehicle.

### SUMMARY

In a first illustrative embodiment, a system includes one or more sensors, one or more output devices, a vehicle computing system (VCS) configured to receive information from the one or more sensors and to output information to the one or more output devices, a wireless receiver in communication with the VCS, and a wireless transmitter in communication with the VCS. The VCS is further configured to filter information received from the one or more sensors and broadcast the information through the wireless transmitter to a first device, while simultaneously communicating with the first device over the wireless receiver to receive a request relating to use of a vehicle output device, to verify the permissibility of the request and to provide output in accordance with a verified request over the vehicle output device.

In a second illustrative embodiment, a computer implemented method includes receiving data relating to a vehicle or vehicle environment at a vehicle computing system (VCS). The method also includes sending the data to a device in wireless communication with the VCS over a first transmitter. The method further includes receiving a request from the device over a first receiver, separate from the first transmitter, while communication is established over the first transmitter. Also, the method includes processing the request to provide access to a vehicle output to the device request.

In a third illustrative embodiment, a computer readable storage medium, stores instructions which, when executed by a vehicle computing system (VCS), causes the system to perform the method including receiving data relating to a vehicle or vehicle environment at a vehicle computing system (VCS). The exemplary method also includes sending the data to a device in wireless communication with the VCS over a first transmitter. Also, the method includes receiving a request from the device over a first receiver, separate from the first transmitter, while communication is established over the first transmitter. The method further includes processing the request to provide access to a vehicle output to the device request.

### BRIEF DESCRIPTION OF THE DRAWINGS

FIG. 1 shows an illustrative vehicle computing system;

FIG. 2 shows an illustrative example of a mobile safety platform;

FIG. 3A shows an illustrative example of a vehicle information delivery process;

FIG. 3B shows an illustrative example of a vehicle information delivery process;

FIG. 4 shows an illustrative example of information handling; and

FIG. 5 shows an illustrative example of a mobile safety platform.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

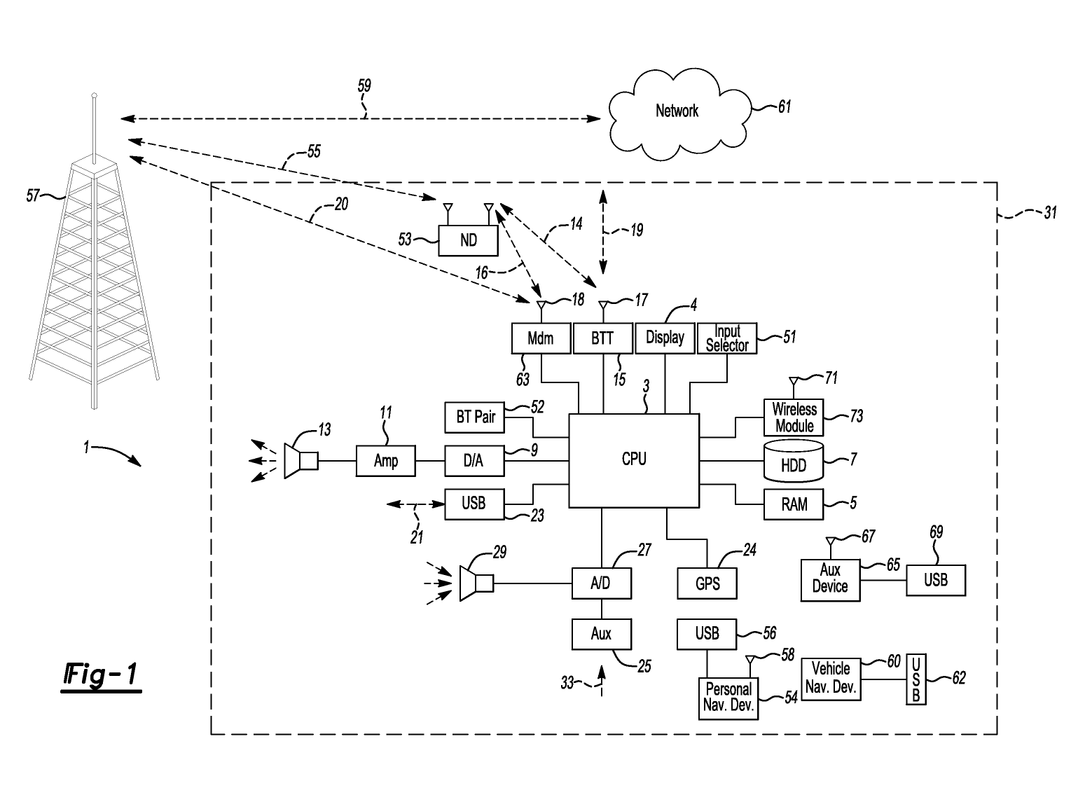

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users.

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

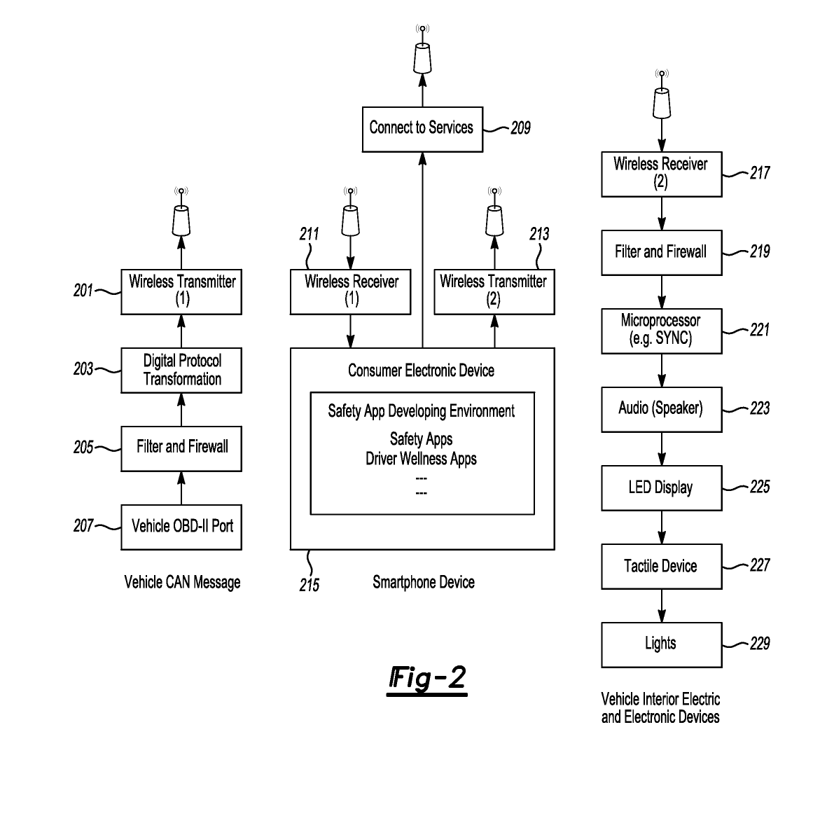

The illustrative embodiment shown in FIG. 2 shows a non-limiting example of a mobile safety platform. In this exemplary platform, a mobile device is equipped with both a wireless receiver and a wireless transmitter, and is capable of communication with two different wireless communication points. In one example, the communication is BLUETOOTH communication and can be between a device and two separate communication points. This provides the capability, in this exemplary embodiment, for secured communication between a vehicle and a device.

In this example, a vehicle has a first transmitting point 201, such as a wireless transmitter. In this example, the communication point transmits, but does not receive information. This allows the broadcasting of information for device pickup without concern about a malicious device or programmer accessing the secure transmission channel.

Messages relating to vehicle states, module states, vehicle conditions, etc. can be broadcasted from a vehicle ODB port 207, which can receive these messages from communication with a vehicle network, such as, for example, a CAN bus. Since there may be information sent/received from the CAN bus that an OEM or driver may not want to expose to transmission, this exemplary platform can also include a firewall/filter 205. The filter can dynamically remove information that should not be exposed to remote devices or malicious access.

Additionally, the information received from the CAN bus may not be in a format suitable for use by a wireless device. Accordingly, the platform may include a process, module, etc. to wrap/package/transform the data into a format suitable for mobile use. The data, once transformed, if needed, can be wrapped for transmission/broadcast.

Once the data is suitably scrubbed and formatted, it can be broadcasted from the vehicle for use by mobile devices/apps, etc. It isn't necessary to transmit the data to a specific device, the data can be broadcasted for use by any device authorized to receive the data. In at least one example, any device could receive the data, although some measure of security protocol may be included with the data (public/private key, etc.) to prevent someone not authorized to view a particular vehicle's data from viewing the data.

In this example, a mobile device 215 with a wireless BLUETOOTH receiver 211 is present to receive the broadcast data. The data, once received by the device, is passed to any relevant applications residing on the device, and can even be passed to the cloud 209 if applications running on the cloud need the data. The device can additionally communicate with the cloud to obtain any data needed for applications running on the mobile device. Any suitable consumer electronic device (smartphone, PDA, tablet computer, laptop, medical device, etc.) can access the data if desired/allowed.

Once the data has been processed by the appropriate applications, if applicable, the device can send any information/messages/requests back to the vehicle. In this example, the messages will not be sent over the same transmission channel as the broadcast vehicle data. In other words, the device will use a second wireless communication point, a transmitter 213, to communicate the data to the vehicle.

In addition to the transmitter 201, the vehicle may be equipped with a wireless receiver 217. This receiver can be paired, for example, with a particular device, so that the vehicle can confirm that the device is authorized to make requests of and/or otherwise access a vehicle computing system. The data is received by the vehicle receiver 217 and is checked for appropriateness by a firewall/filter 219. The filter can remove malicious data, block requests, and otherwise vet incoming data to ensure that only appropriate data passes through to the vehicle computing system.

Once an incoming request has been verified and scrubbed, the process can pass the data/request to a vehicle computing system 221. In at least one example, a developer has been provided with an API that allows communication between mobile applications and a vehicle computing system. The requests can ask for access to vehicle outputs, provide driver alerts, provide application results, etc. For example, health and wellness, or vehicle safety applications can send output to the vehicle for delivery to a driver. Since this information may be distracting to a driver, the vehicle computing system can process the incoming data to ensure that output is not processed over the vehicle outputs that may cause safety concerns.

For example, the vehicle computing system may consider a driver workload and only provide output requests to the driver when a workload is below a safe threshold. On the other hand, if an application provides a high-priority critical alert or update, the output may be process regardless of workload, so that the driver does not miss the critical alert.

In this illustrative example, the outputs accessible by an application request can include, but are not limited to, the vehicle audio system 223, an LED display (e.g., radio) 225, a tactile device 227, vehicle lights 229, etc. Packaged requests can be handled by the VCS and requested data can be delivered to the driver via the appropriate requested format.

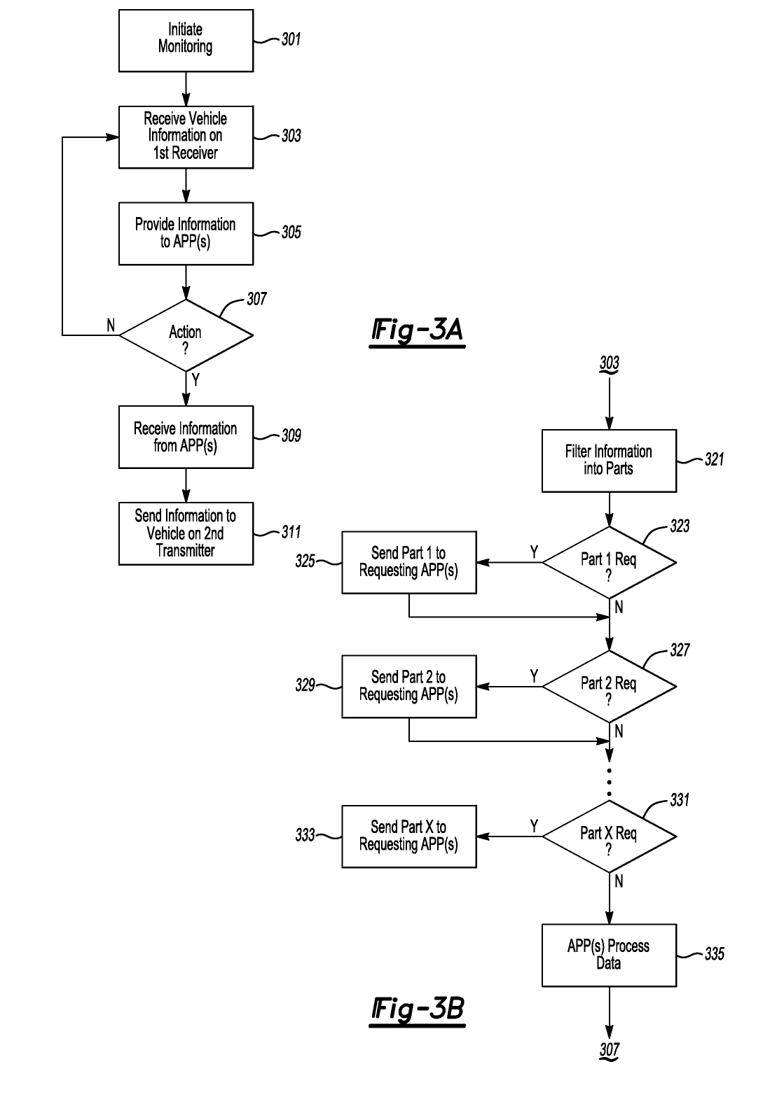

FIG. 3A shows an illustrative example of a data providing process that may be run on a mobile device. In this illustrative example, the process may monitor the vehicle transmitter to see if relevant data is being broadcast. Relevant data can include, but is not limited to, any data, data requested/needed by currently running applications, critical data that may trigger an application launch, etc. Again, in this process, the mobile device on which the process is running is provided with a separate receiver and transmitter.

The wireless receiver can be paired to a vehicle BLUETOOTH transmitter, in one embodiment, or, in another instance, a Wi-Fi or other connection can be used, and the receiver can be configured to receive information over the wireless connection 303. In one embodiment, the vehicle transmitter may broadcast information for use by a plurality of devices. In another embodiment, the process may send the information directly to a paired device.

Once the information has been received by the wireless device, it can be served out to any applications that need/use/have requested the data 305. For example, one or more applications running on the wireless device or in the cloud may use certain vehicle information. Information that may be transmitted may include, but is not limited vehicle state information (longitudinal and lateral accelerations, yaw rate, vehicle speed, brake/steering signals, etc.), environmental information (weather conditions, pre-crash sensor information, etc.), body electronics info (door state, rain sensors, light sensor, etc.), driver wellness signals, which may be detected by vehicle sensors (drowsiness, workload, heart rate, respiration rate etc.), or other relevant, gathered/obtained information.

Applications can have data requests pending with the intermediary application, indicating which types of information they need to receive. Alternatively, the applications can have some or all of any broadcast information delivered to them and the applications themselves can determine if they will perform any use/analysis of the data.

It is also possible that one or more of the applications will produce a result that requests use of a vehicle output system for delivery of information to a driver. For example, a warning/result could be delivered through a vehicle audio system, or displayed on a vehicle display. In this embodiment, the intermediary process checks to see if any use of a vehicle output system is needed by any application(s) 307. If no output is needed, the process may continue to receive and deliver vehicle information.

If one or more applications need to deliver information to the VCS, or request use of one or more outputs from the VCS, the intermediary application may receive the relevant data/request from the requesting application 309. The information can then be passed on to the vehicle system for processing 311. In this embodiment, the information is sent over a second wireless connection, different from the connection on which the information was received. For example, while the information was received on a wireless receiver, this information may be sent on a wireless transmitter separate from the receiver (transceiver(s) can be used if desired).

FIG. 3B shows yet another illustrative example of a process that is part of a mobile wireless/safety platform. In this example, some/all of the vehicle data may be received by the monitoring application, but all of that data may not be needed or even wanted by a given application. According to this embodiment, the intermediary process may break/filter the information into a plurality of relevant parts/packets. For example, if weather, brake and acceleration data was all received as a wrapped data package, the process may break that package into data relating to weather, data relating to braking, and data relating to acceleration 321.

Then, in this example, the process checks to see if any application needs/wants the first part of the data 323. If any application has requested or is requesting the first part of the data, the data can be delivered to the relevant application 325. In another example, all data may be delivered to all applications, but it may be delivered already having been compartmentalized into various relevant parts, so that the particular applications do not need to break up/transform/or otherwise process the data into the individual parts.

The part delivery process can continue 327, 329, 331, 333 until there is no remaining data to be processed. Following delivery of relevant data, the applications can process the data for their individual designs 335 and proceed with delivery of relevant information to a vehicle processing system.

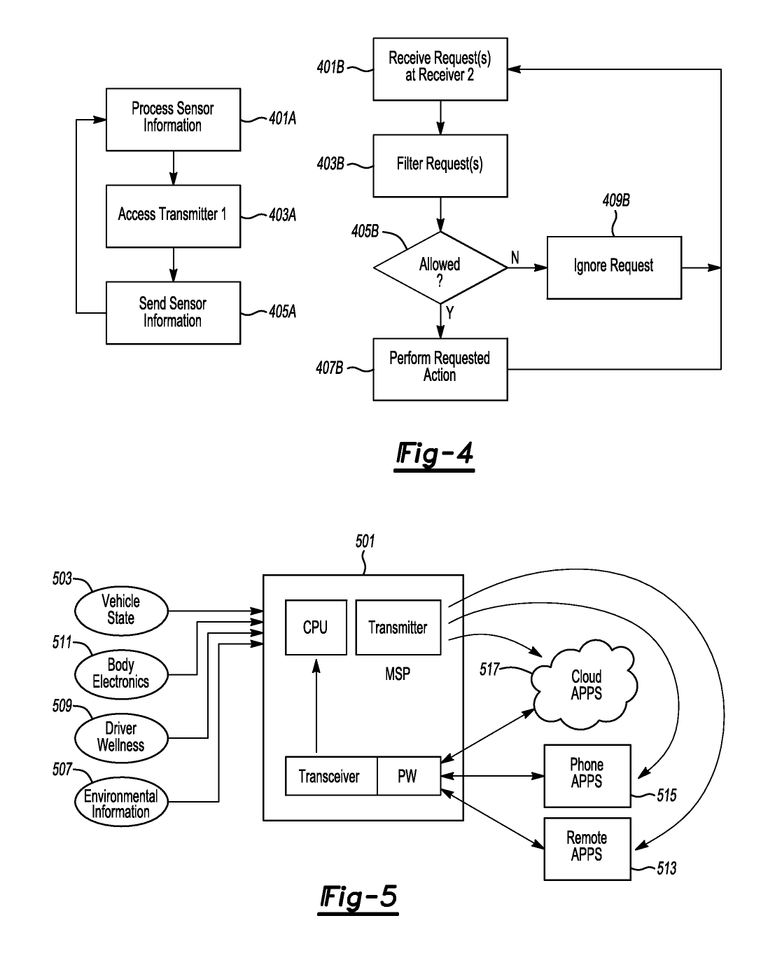

FIG. 4 shows an illustrative example of a vehicle-side process for delivering/receiving information. This illustrative example can be executed by, for example, a vehicle computing system in communication with a wireless device using a single or multi-point BLUETOOTH connection. In one illustrative embodiment, a vehicle side transmitter is in communication with the device for transmission purposes, and a second, separate vehicle side receiver is in communication with the device for reception purposes. The process shown with reference numerals ending in A shows the transmission side process, and the process shown with reference numerals ending in B shows the reception side process. The two processes can be ongoing at the same time in order to both send and receive information in a secure status, with reduced concern about malicious code attacking any vehicle modules.

In this illustrative example, a transmission side process first processes information from one or more vehicle sensors 401A. This can include, but is not limited to, restraint control module sensors (RCM), tire pressure sensors, weather condition sensors, temperature sensors, accel/decel sensors, traction control sensors, health sensors, etc. The information can then be stripped of any data that should not be passed to a remote device, and the process can access the first transmitter 403A. The process can then broadcast or transmit the filtered (or unfiltered) sensor information to a remote device 405A.

At the same time, if desired, a receiving process can be ongoing. The process can receive, at a receiver separate from the transmitter in this exemplary case, a request from a remote process to access a vehicle system 401B. The request can be filtered/firewalled as appropriate, to check for permissions and the presence of malicious data/code 403B. If the request is permissible 405B, the process can perform a requested action 407B, or queue a requested action for processing when a cycle is available. If the request is improper or not permitted, the process can ignore the request 409B (with or without a response and/or warning to a driver).

FIG. 5 shows an exemplary diagram of an entire mobile communication system, with a variety of exemplary elements included therewith. In this example, the center of the system is a vehicle computing system, including a mobile safety platform 501. The mobile safety platform can be configured to communicate with a variety of remote devices and processes, and can relay safety (or other) information to these devices and processes for additional use and processing.

The mobile safety platform is capable of delivering a variety of data to various applications and processes remote from the vehicle computing system. In this example, this includes, but is not limited to, body electronics data 511, vehicle state data 503, driver/occupant wellness data 509 and environmental information data 507. This data can be obtained by the mobile safety platform from a variety of vehicle systems, and can be served out on a broadcast or per-request basis to any and all requesting devices, as appropriate.

In this example, the data is accessed by such remote processes including, but not limited to, phone based applications 515, such as those run on a smartphone, remote PC-based applications 513, such as those run on a tablet PC or other portable computer, and cloud based applications 517, which can be accessed through, for example, communication between a vehicle and a remote server through a wireless device.

The data can be sent in isolated packets, as a data feed, in response to data requests, or in any other suitable format deemed appropriate. The data, in this example, is sent from a transmitter separate from a receiver (or transceiver), so that a measure of security in the vehicle system can be maintained.

Additionally, the various applications can communicate data and requests back to the mobile safety platform, which receives those requests on a separate receiver (or transceiver) and passes the requests through a firewall. The requests, which are limited in their capacity to affect vehicle systems, can be passed to a CPU for processing and access, on a restricted basis, to vehicle systems.

In addition, each of the remote devices/applications/processes may be capable of communication back to the mobile safety platform. This can be achieved, for example, through the use of a separate receiver, which can receive remote requests, filter them, and deliver the requests to the appropriate vehicle system for further processing. In this manner, a secure mobile safety system can be maintained without compromising the integrity of critical vehicle systems, such as vehicle networks (e.g., a CAN bus) or other vehicle modules.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
one or more sensors;
one or more output devices;
a vehicle computing system (VCS) configured to receive information from the one or more sensors and to output information to the one or more output devices;
a wireless receiver in communication with the VCS; and
a wireless transmitter in communication with the VCS, wherein
the VCS is further configured to filter information received from the one or more sensors and broadcast the information through the wireless transmitter to a first device, while simultaneously communicating with the first device over the wireless receiver to receive a request relating to use of a vehicle output device, to verify the permissibility of the request and to provide output in accordance with a verified request over the vehicle output device.

2. The system of claim 1, wherein the sensors include environmental sensors.

3. The system of claim 1, wherein the sensors include vehicle component sensors.

4. The system of claim 1, wherein the sensors include occupant health and wellness sensors.

5. The system of claim 1, wherein the sensors include vehicle motion related sensors.

6. The system of claim 1, wherein the transmitter and receiver are BLUETOOTH capable.

7. The system of claim 1, wherein the transmitter and receiver are WiFi capable.

8. A computer implemented method comprising:
receiving data relating to a vehicle or vehicle environment at a vehicle computing system (VCS);
sending the data to a device in wireless communication with the VCS over a first transmitter;
receiving a request from the device over a first receiver, separate from the first transmitter, while communication is established over the first transmitter; and
processing the request to provide access to a vehicle output to the device request.

9. The method of claim 8, wherein the first transmitter and the first receiver are BLUETOOTH capable.

10. The method of claim 8, wherein the first transmitter and the first receiver are WiFi capable.

11. The method of claim 8, wherein the data includes environmental data.

12. The method of claim 8, wherein the data includes vehicle state data.

13. The method of claim 8, wherein the data includes data relating to one or more vehicle components.

14. The method of claim 8, wherein the data includes occupant health and wellness data.

15. A computer readable storage medium, storing instructions which, when executed by a vehicle computing system (VCS), cause the system to perform the method comprising:
receiving data relating to a vehicle or vehicle environment or occupant at a vehicle computing system (VCS);
sending the data to a device in wireless communication with the VCS over a first transmitter;
receiving a request from the device over a first receiver, separate from the first transmitter, while communication is established over the first transmitter; and
processing the request to provide access to a vehicle output to the device request.

16. The method of claim 15, wherein the first transmitter and the first receiver are BLUETOOTH capable.

17. The method of claim 15, wherein the first transmitter and the first receiver are WiFi capable.

18. The computer readable storage medium of claim 15, wherein the data includes environmental data.

19. The computer readable storage medium of claim 15, wherein the data includes vehicle state data.

20. The computer readable storage medium of claim 15, wherein the data includes data relating to one or more vehicle components.

21. The computer readable storage medium of claim 15, wherein the data includes occupant health and wellness data.
